(19) United States
(12) Patent Application Publication
(10) Pub. No.: US 2025/0369535 A1
(43) Pub. Date: Dec. 4, 2025

(54) ISOLATION SYSTEM AND METHODS FOR SUBSEA PIPELINES

(71) Applicant: PETRÓLEO BRASILEIRO S.A. – PETROBRAS, Rio de Janeiro (BR)

(72) Inventors: Marcos Hideo Da Silva MASHIBA, Rio de Janeiro (BR); Junior Dos Santos SILVA, Rio de Janeiro (BR); Andre Luiz Rocha ALVES, Rio de Janeiro (BR); Jefferson RODRIGO DE SOUZA, Rio de Janeiro (BR); Guilherme DE SOUZA AIRES, Rio de Janeiro (BR)

(21) Appl. No.: 19/196,951

(22) Filed: May 2, 2025

(30) Foreign Application Priority Data
May 28, 2024 (BR) 1020240106237

(51) Int. Cl. F16L 1/26; F16L 55/10

(52) U.S. Cl. CPC F16L 1/26; F16L 55/1022

(57) ABSTRACT

The present disclosure relates to a subsea pipeline isolation system and methods. An embodiment of a system includes a subsea isolation valve, a mechanically actuated ball valve, a first hydraulic gate valve, a second hydraulic gate valve, a mechanically actuated gate valve, recoverable electric actuator, pressure compensation systems, instrumentation and a monitoring system having a pressure transducer and a pressure and temperature transducer, mounted on a multiple quick connector. Embodiments of the isolation systems and methods offers greater control and operational flexibility and efficiency in gas flow through subsea pipelines, and is designed to address specific challenges in subsea operations, such as leak isolation and subsea pipeline maintenance.

### FIELD OF THE DISCLOSURE

The present disclosure falls within the field of subsea and oil engineering, with emphasis on systems and equipment used in the oil and gas exploration and production industry in subsea environments.

The system of the present disclosure is designed to deal with specific challenges in subsea operations, such as leak isolation and maintenance of subsea pipelines, integrating improved technologies to ensure safe and efficient operations.

### BACKGROUND OF THE DISCLOSURE

The Piper Alpha platform disaster on Jul. 6, 1988 resulted in significant loss of human lives and extensive material damage. The platform lacked mechanisms capable of isolating the subsea gas lines. When flammable gas leaked from a high-pressure pipeline, the existing emergency control system did not allow the flow to be stopped, as there was no gas inventory isolation valve in the subsea section.

The lack of an effective isolation device allowed gas to continue leaking, feeding the subsequent fire. The situation became even more critical when the flammable gas reached areas where production operations were underway, triggering a series of devastating explosions. Following the tragedy, several measures were implemented to mitigate the impacts associated with the gas inventory in subsea pipelines, in particular during emergency situations. Among these, the implementation of subsea isolation valves (SSIVs) in gas pipelines stands out as a preventive measure.

SSIVs are critical components in control and safety systems used in oil and gas exploration and production in subsea environments. These valves are designed to stop the flow of fluids, such as gas or oil, in subsea pipelines during emergencies such as leaks, fires or other threats to the system integrity.

SSIVs play a fundamental role in operational safety, as they have the ability to isolate specific sections of subsea pipelines, preventing the spread of leaks and minimizing associated risks. In the event of a contingency, SSIVs can be closed remotely, stopping the flow of fluids and isolating the affected area.

The search for improved safety in subsea installations led to the need to define the strategic placement of the safety valves along the pipeline, taking into account factors such as the maximum time that the safety components of the platform could withstand a fire fueled by the pipeline inventory.

Ever since this milestone, SSIV maintenance has typically required the assistance of support vessels, which involves significant logistical challenges and operational impacts. Reliance on these vessels for carrying out watertightness tests and maintenance interventions leads to increased operating costs, added complexity in offshore operations, as well as extended downtime of the drainage systems. The need to mobilize vessels for inspection and testing activities extends the emergency response times and restricts operational flexibility, leading to the need for alternatives for performing sealing tests.

Thus, the present disclosure provides a solution for the need of greater agility in installation and maintenance while reducing the operational costs by providing a robust system capable of performing tests and isolation procedures of pipelines in a subsea environment without the need for support vessels.

### STATE OF THE ART

Document CN113237611A describes a special device for testing underwater rapid isolation device. This device aims to verify the operational performance of a pneumatic isolation device in subsea conditions, in particular during the installation of a nuclear cooling system. The device includes components such as an isolation equipment control unit, emergency gas supply electric valves, a test barrel, an isolation device body, and an emergency gas source. The disclosed device performs sealing tests on isolation equipment chambers, monitors subsea pressure, and performs positive sealing tests. The test is carried out under simulated subsea working conditions. In connection with the present disclosure, it is noted that both devices share the purpose of testing the performance of subsea isolation equipment, but differ in terms of specific application, components and test methods.

The present disclosure, unlike document CN113237611A, deals with a more comprehensive system that involves five distinct subsystems (safety isolation, pressure compensation, testing, gas pressure/temperature monitoring and chemical injection). Each subsystem has specific functionalities to ensure the safety and operational efficiency of a subsea gas pipeline.

Document CN104633239A describes a remotely controlled subsea isolation valve system that is mainly composed of three parts, wherein the first part includes subsea isolation valves, the second part includes an umbilical cable and fly wires, and the third part includes a platform hydraulic pressure unit (HPU). The platform HPU is connected to a subsea isolation valve actuator through the umbilical cable and fly wires. Hydraulic pressure is supplied to the actuator through hydraulic power lines in the umbilical cable and the fly wires, and the actuator is operated to switch on or switch off the valves. Meanwhile, switching signals of the valves are fed back to a platform center control system through the umbilical cable and electric cables in the fly wires. If a hydraulic system breaks down or has other requirements, the actuator can be operated mechanically by using an ROV torque tool, and then switching operation of the subsea isolation valves can be achieved.

In this sense, it is evident that none of the documents describes the substantial improvements disclosed by the present disclosure, such as the use of a recoverable electric actuator, a gate valve with hydraulic actuation in the isolation of sensors, and the application of temperature and pressure transducers. These features aim to ensure greater autonomy in carrying out tests from the production unit by eliminating the dependence on support vessels.

### SUMMARY OF THE DISCLOSURE

The present disclosure proposes a subsea pipeline isolation system containing a valve block, which comprises a subsea isolation valve (SSIV), a mechanically actuated ball valve (MBV), a hydraulic gate valve 1 (HGV-1), a hydraulic gate valve 2 (HGV-2), a mechanically actuated gate valve (MGV), a recoverable electric actuator, a pressure compensation system, instrumentation, and a monitoring system comprising a pressure and temperature transducer (TPT) and a pressure transducer (PT) mounted on a multiple quick connector 2 (MQC-2).

The subsea isolation valve (SSIV) is a ball valve, with single (SPE) and double (DPE) piston effect seats, with the SSIV actuator being a spring return hydraulic actuator, with a rotary override, being powered by four hydraulic functions, F1 to F4, through a multiple quick connector 1 (MQC-1).

In turn, the mechanically actuated ball valve (MBV) has single (SPE) and double (DPE) piston effect seats, having an auxiliary function in SSIV tests.

Hydraulic gate valve 1 (HGV-1) has a spring return hydraulic actuator provided with a rotary override interface and allows communication or isolation of the defined volume between the SSIV and the MBV with the pressure and temperature transducer (TPT) through the multiple quick connector 2 (MQC-2).

Moreover, the hydraulic gate valve 2 (HGV-2) also has a spring return hydraulic actuator provided with a rotary override and enables the injection of chemicals into the system via multiple quick connector 1 (MQC-1).

Finally, the mechanically actuated gate valve (MGV) only has a torque actuation interface for operation via ROV, being a contingency for isolating access to the defined volume between the SSIV and the MBV in the event of HGV-1 failure.

It is worth noting that SSIV, MGV, HGV-1, HGV-2 and MBV may have independent and resident pressure compensation systems, being an integral part of the hydraulic actuator assembly. However, it is desirable that hydraulically actuated valves (SSIV, HGV-1 and HGV-2) have pressure compensation systems with the possibility of recovery to the surface.

It is also worth noting that the SSIV, HGV-1, HGV-2 valves are of the Fail Safe Closed type (FSC), while MGV and MBV valves are Normally Open (NO).

### BRIEF DESCRIPTION OF THE DRAWINGS

the present disclosure will now be described with reference to typical embodiments thereof and also with reference to the attached drawings, in which:

FIG. 1 is a representation according to an embodiment of the present disclosure that considers the use of resident individual pressure compensation systems.

FIG. 2 is a representation according to an embodiments of the present disclosure considering the use of a recoverable shared pressure compensation unit for hydraulically actuated valves.

### DETAILED DESCRIPTION OF THE DISCLOSURE

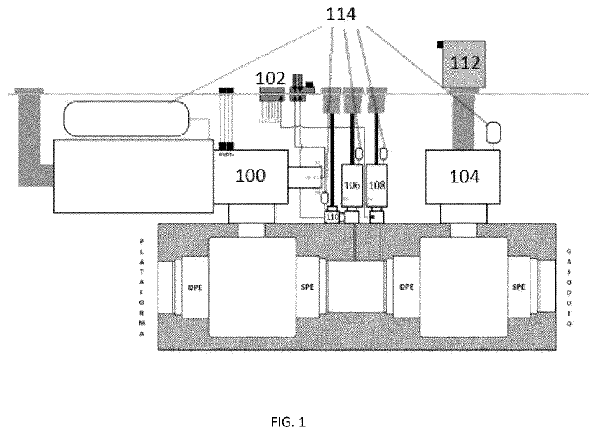

The subsea pipeline isolation system aims at the safe and efficient isolation of subsea gas pipelines,
providing greater operational control and reducing the associated risks. The system, as shown in FIG. 1, is composed of several assemblies synergistically interconnected, each performing specific functions to ensure the effective isolation of the gas inventory.

The assemblies include: a valve block, a recoverable electric actuator, a pressure compensation system, a instrumentation and monitoring system.

The valve block comprises several valves strategically placed and interconnected to perform specific functions. The first one is the subsea isolation valve (SSIV) (100), which is the main valve in the system and operates by blocking the flow of gas in the pipeline, thus reducing inventory and mitigating potential risks.

The SSIV (100) is a ball valve with single (SPE) and double (DPE) piston effect seats, ensuring an effective metal-to-metal seal between the ball and the seats. The SSIV actuator is a spring return hydraulic actuator provided with a rotary override, being controlled by hydraulic functions F1 to F4, interconnected to MQC-1 (102).

In addition to the SSIV (100), the valve block further includes other complementary valves for specific functions. The mechanically actuated ball valve (MBV) (104) is an auxiliary valve used to enable SSIV (100) testing and has single (SPE) and double piston effect (DPE) seats.

Hydraulic gate valve 1 (HGV-1) (106) is used to isolate or communicate the pressure and temperature transducer for monitoring the volume defined between the SSIV (100) and the MBV (104). This valve features a spring return hydraulic actuator provided with a rotary override, being controlled by hydraulic function F5 interconnected to the MQC-1 (102).

In turn, hydraulic gate valve 2 (HGV-2) (108) is used to allow the injection of chemicals. Like the HGV-1 (106), the HGV-2 (108) also features a spring return hydraulic actuator with a rotary override.

Furthermore, the mechanically actuated gate valve (MGV) (110) is used to isolate the system in the event of failure in the multiple quick connector connection 2 (MQC2). This valve is a gate type valve and is manually operated. MQC2 is a type of connector that is designed to allow rapid connection and disconnection of multiple control lines, power supply, and communication signals between subsea equipment and the surface, through subsea umbilicals.

In a preferred embodiment, the system features a recoverable electric actuator (112), with Fail Safe Closed (FSC) which means that it can be easily installed, removed and replaced when necessary by using a remotely operated vehicle (ROV) for its manipulation. If the electric actuator (112) has a fail-safe feature, the MBV valve can be considered a contingency in the event of failure of the main safety valve, the SSIV (100), which increases the operational safety of the system.

In addition, the electric actuator is provided with a remote control interface, allowing it to be operated and monitored from the surface via subsea control systems.

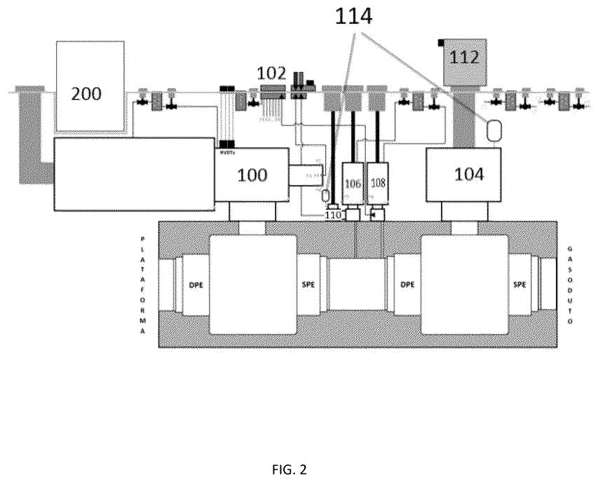

In a preferred embodiment, as shown in FIG. 2, the system has a recoverable shared pressure compensation unit designed to ensure reliable and safe operation of the subsea valves under several conditions. The purpose of this unit is to compensate for the volume and pressure changes which the system is subjected to hence, ensuring that the valves function correctly at different sea depths, eliminating the need for individual resident pressure compensation units (114) in the hydraulically actuated valves, HGV-1 (106), HGV-2 (108) and SSIV (100).

On the other hand, the mechanically actuated valves, MBV (104) and MGV (110), use individual resident compensators, ensuring their proper operation under different subsea conditions.

In an alternative embodiment, as shown in FIG. 1, the SSIV (100), HGV-1 (106), and HGV-2 (108) valves may also have individual resident pressure compensators (114), without the need for a recoverable shared pressure compensation unit.

The instrumentation of the system of the present disclosure is critical for the precise monitoring and control of subsea operations. One of the key components is the Pressure and Temperature Transducer (TPT) mounted to the MQC-2 to allow its recovery in case of failure.

The TPT performs the important task of accurately measuring pressure and temperature of the gas flowing during the SSIV tightness test and connects to the volume between the SSIV and MBV valve plugs via the HGV-1 and MGV isolation valves.

In addition, the monitoring system includes a pressure transducer (PT) interconnected to the MQC-2 to allow monitoring of the SSIV actuation pressure.

The chemical product injection assembly is composed of the HGV-2 gate valve actuated via hydraulic function F6 and interconnected to the MQC-1, being responsible for allowing the injection of MonoEthylene Glycol (MEG) to prevent the formation of hydrates during prolonged shutdowns of the gas line. These components are critical for ensuring the safety and efficacy of the system of the present disclosure in subsea operations.

Furthermore, it should be noted that some sealing tests can be performed to assess the proper sealing of the valves in the system of the present disclosure, namely: SSIV sealing test with liquid; SSIV sealing test with gas; and MBV sealing test with gas. The hydraulic functions of valves under normal operating conditions are the following: SSIV—open; MBV—open; HGV-1—closed; HGV-2—closed.

SSIV Sealing Test with Liquids

First, there is a need to shut down the export of gas through the surface facilities of the production unit. The first step is the closure of the MBV using the electric drop-in-place actuator followed by venting the riser into the atmosphere. Then, the SSIV is closed, venting hydraulic functions F1, F2, F3 and F4, while recording the time required for the full closure of the valve via the rotary variable differential transformer (RVDT) sensor signal as part of the functional test.

Thereafter, HGV-1 and HGV-2 are opened by pressurizing hydraulic functions F5 and F6, respectively. Subsequently, HGV-2 is closed, venting hydraulic function F6 to isolate the pressure source. Then, pressure in the test cavity of the isolation system of the present disclosure is allowed to stabilize while the pressure and temperature are recorded using the TPT for 2 hours, ensuring that the variation is less than or equal to 5% of the test pressure per hour.

At the end of the sealing test, the HGV-1 is closed by venting hydraulic function F5. Then, the pressure is vented into the test cavity of the isolation system of the present disclosure by opening the SSIV through the pressurization of hydraulic functions F1, F2, F3 and F4, while recording the time required for the full opening of the valve through the RVDT signal. This procedure also prevents formation of hydrates by the MEG entering the SSIV body cavity.

To complete the process, the riser is pressurized from the production unit to equalize with the pipeline pressure, and finally the MBV is opened by means of the electric drop-in-place actuator, thus allowing the pipeline to be restarted from the production unit.

SSIV Sealing Test with Gas

First, there is a need to shut down the export of gas through the surface facilities of the production unit. Accordingly, the SSIV is closed by venting hydraulic functions F1, F2, F3 and F4, while recording the time required for the valve to fully close through the RVDT signal, as part of the functional test. The MBV is then closed using the electric drop-in-place actuator.

Then, HGV-1 is opened by pressurizing hydraulic function F5. The pressure in the riser is then reduced to create a pressure differential of between 800 psi and 1000 psi across the SSIV. Pressure in the test cavity of the isolation system of the present disclosure is then allowed to stabilize while ensuring that the variation is less than or equal to 5% of the test pressure per hour. Pressure and temperature in the test cavity of the isolation system of the present disclosure are recorded by the TPT for 2 hours.

At the end of the sealing test, the HGV-1 is closed by venting hydraulic function F5. Next, the riser is pressurized from the production unit to equalize with the pressure in the test cavity of the isolation system of the present disclosure and then the SSIV is opened by pressurizing hydraulic functions F1, F2, F3 and F4, while recording, through the RVDT signal, the time required for the valve to fully open.

Finally, the MBV is opened using the electric drop-in-place actuator, thus allowing the gas pipeline to be restarted from the production unit.

MBV Sealing Test with Gas

First, there is a need to shut down the export of gas through the surface facilities of the production unit. The MBV is closed using the electric drop-in-place actuator. Pressure in the riser is then reduced to create a pressure differential of between 800 psi and 1000 psi across the MBV and then the SSIV is closed by venting the hydraulic functions F1, F2, F3 and F4.

Subsequently, HGV-1 is opened by pressurizing hydraulic function F5. Pressure in the test cavity of the system of the present disclosure is then allowed to stabilize while ensuring that the variation is less than or equal to 5% of the test pressure per hour. Pressure and temperature in the test cavity of the system of the present disclosure are recorded by the TPT for 2 hours.

At the end of the sealing test, the HGV-1 is closed by venting hydraulic function F5. The SSIV is then opened by pressurizing hydraulic functions F1, F2, F3 and F4.

Finally, the riser from the production unit is pressurized to equalize with the pipeline pressure and then the MBV is opened by means of the electric drop-in-place actuator, thus allowing the restart of the gas pipeline from the production unit.

Thus, it is evident that the system of the present disclosure is advantageous due to its operational autonomy, allowing the performance of tightness test in a reduced time without the need for a support vessel, which provides greater flexibility, independence and economy to the operations of the production unit, in addition to providing multiple layers of protection in the event of failures or technical issues.

Although aspects of the present disclosure may be subject to various modifications and alternative forms, specific embodiments have been illustrated by way of example in the drawings and described in detail herein. It should be understood that the disclosure is not intended to be limited to the particular forms disclosed herein. Instead, the disclosure is intended to cover all modifications, equivalents and alternatives falling within the scope of the disclosure as defined by the appended claims.

1. A subsea pipeline isolation system, the system comprising:
a. a valve block containing: a subsea isolation valve, a mechanically actuated ball valve, a first hydraulic gate valve, a second hydraulic gate valve, and a mechanically actuated gate valve;
b. a recoverable electric actuator;
c. a pressure compensation unit;
d. instrumentation; and
e. a monitoring system comprising a pressure and temperature transducer and a pressure transducer, mounted on a multiple quick connector.

2. The system according to claim 1, wherein the subsea isolation valve comprises:
a ball valve with single (SPE) and double (DPE) piston effect seats; and
a spring return hydraulic type provided with a rotary override, being controlled by hydraulic functions F1 to F4.

3. The system according to claim 1, wherein the mechanically actuated ball valve comprises:
a ball valve with single and double piston effect seats, and
a mechanical actuator with a gearbox.

4. The system according to claim 3, wherein the is a mechanically operated auxiliary valve for testing in the SSIV.

5. The system according to claim 1, wherein the first hydraulic gate valve comprises:
a gate valve, and
a spring return hydraulic actuator provided with a rotary override being controlled by hydraulic function.

6. The system according to claim 1, wherein the first gate valve isolates or communicates with the pressure and temperature transducer, through the multiple quick connector.

7. The system according to claim 1, wherein the second hydraulic gate valve comprises:
a gate valve, and
a spring return hydraulic actuator provided with a rotary override being controlled by hydraulic function F6.

8. The system according to claim 1, wherein the mechanically actuated gate valve comprises:
a gate valve, and
a mechanical actuator with a rising stem.

9. The system according to claim 1, wherein the mechanically actuated gate valve and the mechanically actuated ball valve exhibit individual, resident pressure compensation systems.

10. The system according to claim 1, wherein the subsea isolation valve, first gate valve, and second gate valve exhibit a recoverable shared pressure compensation unit.

11. The system according to claim 1, wherein the subsea isolation valve, first gate valve, and the second gate valve are of the Fail Safe Closed type.

12. The system according to claim 1, wherein the MGV and MBV valves are of the normally open type.
